(19) United States
(12) Patent Application Publication
(10) Pub. No.: US 2023/0419612 A1
(43) Pub. Date: Dec. 28, 2023

(54) VIRTUAL GALLERY SPACE SYSTEM

(71) Applicant: POLYCARBON BLOCKCHAIN, INC., OAKLAND, CA (US)

(72) Inventors: Eric MATSUNO, Oakland, CA (US); Jamel Williams, Fremont, CA (US)

(21) Appl. No.: 18/340,078

(22) Filed: Jun. 23, 2023

Related U.S. Application Data
(60) Provisional application No. 63/355,284, filed on Jun. 24, 2022.
(60) Provisional application No. 63/417,061, filed on Oct. 18, 2022.

(51) Int. Cl. G06T 19/00; G06T 15/10

(52) U.S. Cl. CPC G06T 19/00; G06T 15/10; G06F 3/0486

(57) ABSTRACT

A method, system and for rendering customizable 3D environments. The method includes generating a universal rendering package, including a base visual profile comprising one or more of a 3D visual representation, a 2D visual representation, a document and a portal. The universal rendering package is transmitted to a rendering engine. The 3D environment is generated with the universal rendering package. The 3D environment includes the base visual profile.

### CROSS REFERENCE TO RELATED APPLICATIONS

This application is a non-provisional patent application claiming priority and benefit of U.S. Provisional Patent Application No. 63/355,284, filed Jun. 24, 2022, entitled “VIRTUAL GALLERY SPACE SYSTEM AND METHOD FOR DISPLAY AND TRANSFER OF NON-FUNGIBLE TOKENS”, currently pending, and U.S. Provisional Patent Application No. 63/417,061, filed Oct. 18, 2022, entitled “CURATOR FOR VIRTUAL GALLERY SPACE SYSTEM”, currently pending, each of which is hereby incorporated by reference in its entirety.

### FIELD OF THE INVENTION

The present invention is directed to methods and systems relating to rendering customizable 3D environments, including virtual gallery and mall spaces.

### BACKGROUND OF THE INVENTION

Users are spending more and more time in digital environments. Such digital environments are provided by content providers. Example digital environments include social networks, video games, virtual realities (VR) and digital platforms. Typically, the user interacts with the digital environment with an intended purpose. The digital environment receives input from the user and provides output on a display of an electronic device being used by the user, such as a smartphone, a personal computer, a laptop computer, or specialized game device. While spending time in these environments, among other activities, they may view and purchase digital assets.

While interacting with digital environments, the user may view the virtual environment on their display. Often, an avatar corresponding to the user is presented on the display so that the user perceives that they are a participant “in” the virtual environment. An avatar is an icon or graphical figure that represents the user. Other avatars may be visible to the user while playing the game. Some avatars may represent game artifacts, such as physical objects or game characters that the user interacts with. In addition, a user may “enter into” a digital VR environment where the user views a virtual reality world using a VR headset. In some digital VR environments, other people who are in the VR environment are visible to the user as avatars. The user may interact with the other avatars to simulate personal interactions between the user and the other people represented by their avatar.

Selling digital assets online is generally a known activity. However, the sales experience and purchasing processing are unsatisfactory. In sales environments in known systems, the digital assets are in static three-dimensional (3D) environments or two-dimensional (2D) representations of these assets. These do not provide the proper experience, particularly when the assets are 3D renderings or other 3D representation. Furthermore, purchasing and acquiring digital assets takes multiple steps and requires several kinds of technologies and transactions in order to acquire and record the sale. The metaverse is a vehicle through which these transactions may take place. The metaverse is a platform that requires different technology than standard online transactions and interactions.

Digital assets include one type of representation that may be presented in a 3D environment. For example, a digital asset may be represented by a Non-Fungible Token (NFT) as the unique fingerprint, which, upon creation, may be recorded in a block of a public blockchain architecture. The data in the block may include information relating to authorship, ownership, transfer history and the date of creation of the digital asset. Registration of the digital asset on the blockchain provides the purchaser of the digital asset the rights to utilize or further transfer the digital asset. NFTs includes various information of interest that are associated with the particular instance of a digital asset. For example, the information in the NFT may include information, such as descriptions or code related to a digital asset as well as identify the content provider, identify the creation date of the branded digital item, and/or identify the edition number of the branded digital item. Examples of digital assets include, but are not limited to creative works, digital images, video content, or other digital works. However, existing technologies fail to provide an adequate way to showing these digital assets in a 3D environment.

The blockchain architecture of distributed ledgers records and validates ownership rights in digital assets. When a digital asset transfer is requested, upon validation of the purchase and identity of the buyers, a hash of a digital representation of the digital asset is created as a NFT representing the unique, immutable, and irrefutable fingerprint of the registration of the asset in conjunction with evidence of authorship and creation. The hash is communicated to one or more nodes of a peer-to-peer network to generate an entry in a public ledger to grant ownership rights to the purchaser. The evidence of identity of the natural or legal person is a public key of a wallet stored on the public ledger and owned by the natural or legal person.

The decentralized digital assets ledger system allows creators to increase control of their works, reduce transaction costs and friction, i.e., the ability to get to market faster and with less cost by removing the need for complex legal systems and proprietary rights management systems with large network infrastructures.

In order to facilitate efficient display and sale of digital visual representations, such as digital art or other digital assets represented by items such as NFTs, it is desirable to display the visual representations in a dynamic 3D, virtual or augmented reality environment, where both a simplified configuration of the environment and digital assets and the user interaction and purchase of digital assets takes place within a live-social 3D environment, a Social Reality. Current systems for display and/or sale of digital assets fail to provide such configuration and interaction within dynamic 3D, virtual or augmented reality environments.

Current technology requires an engineer or engineer level expertise to configure assets within a gallery space in Web 3.0 and the Metaverse. Installing and changing assets involves a complex set of tedious steps to change a single image. These complications compound quickly when multiple images ore representations are involved, requiring significant amounts of time.

Word Press (available from Automattic, Inc.) is an application that is widely used for simplifying the creation and modification of 2D, web 2.0 websites. 3D creation and modification currently is accomplished using tools, such as Unity (available from Unity Technologies) and Unreal (available from Epic Games, Inc.). However, these tools are programming tools, which are complicated and require a high level of technical knowledge and lack flexibility. There currently are not any tools for Web 3.0/metaverse that offer the same ease of use Word Press. There is currently nothing available in the virtual environments, including web 3.0 applications and sites.

A great deal of art and science goes into maximizing the location of objects for sale in retail stores. Product placement can make the difference between being seen and sold or not seen at all. Scheduling objects for sale during, and after an event or an announcement is paramount to the sale of many products. Current solutions for virtual display and sale of digital assets fail to provide customizability and the desired visual experience need to facilitate the effective display and sale of digital assets.

A method and system for easily rendering and customizing 3D environments including visual representations, such as digital assets represented by NFTs that show one or more improvements in comparison to the prior art would be desirable in the art.

### SUMMARY OF THE INVENTION

In an embodiment, a method for rendering customizable 3D environments. The method includes generating a universal rendering package, including a base visual profile comprising one or more of a 3D visual representation, a 2D visual representation, a document and a portal. The universal rendering package is transmitted to a rendering engine. The 3D environment is generated with the universal rendering package. The 3D environment includes the base visual profile.

In certain aspects of the invention, a frame including the base visual profile is provided. The frame is edited from a viewpoint of a 3D avatar to create a modified visual profile. The universal rendering package is modified to include the modified visual profile. The universal rendering package is transmitted to the rendering engine and a modified 3D environment is generated with the universal rendering package. The modified 3D environment includes the modified visual profile.

In another embodiment, a non-transitory machine-readable storage medium storing one or more sequences of instructions for rendering customizable 3D environments is provided, which when executed by one or more processors, cause a universal rendering package to be generated, the universal rendering package including a base visual profile comprising one or more of a 3D visual representation, a 2D visual representation, a document and a portal. The universal rendering package is caused to be transmitted to a rendering engine and the 3D environment is caused to be generated with the universal rendering package. The 3D environment includes the base visual profile.

In certain aspects of the invention, the non-transitory machine-readable storage medium causes in the 3D environment, a frame to be provided including the base visual profile. The frame from a viewpoint of a 3D avatar is caused to be edited to create a modified visual profile. The universal rendering package is caused to be modified to include the modified visual profile. The universal rendering package is caused to be transmitted to the rendering engine and a modified 3D environment is caused to be generated with the universal rendering package. The modified 3D environment includes the modified visual profile.

In another embodiment, a computer system configured to render a customizable 3D environment. The system includes a server including one or more processors and a remote processing device including one or more processors. Each of the server and the remote processing device have one or more computer-readable storage mediums storing one or more sequences of instructions, which when executed, cause a universal rendering package to be generated, the universal rendering package including a base visual profile comprising one or more of a 3D visual representation, a 2D visual representation, a document and a portal. The universal rendering package is caused to be transmitted to a rendering engine and the 3D environment is caused to be generated with the universal rendering package. The 3D environment includes the base visual profile.

In certain aspects of the invention, the computer system causes, in the 3D environment, a frame to be provided including the base visual profile. The frame from a viewpoint of a 3D avatar is caused to be edited to create a modified visual profile. The universal rendering package is caused to be modified to include the modified visual profile. The universal rendering package is caused to be transmitted to the rendering engine and a modified 3D environment is caused to be generated with the universal rendering package. The modified 3D environment includes the modified visual profile.

Other features and advantages of the present invention will be apparent from the following more detailed description, taken in conjunction with the accompanying drawings which illustrate, by way of example, the principles of the invention.

### BRIEF DESCRIPTION OF DRAWINGS

FIG. 1 schematically illustrates a computer system including blockchain networks according to an embodiment of the present disclosure.

FIG. 2 schematically illustrates a computing device according to an embodiment of the present disclosure.

FIG. 3 illustrates a process flow for rendering customizable 3D environments according to an embodiment of the present disclosure.

FIG. 4 illustrates a process flow for rendering customizable 3D environments according to an alternate embodiment of the present disclosure.

FIG. 5 schematically illustrates a process for customizing 3D environments according to an embodiment of the present disclosure.

FIG. 6 schematically illustrates a computer system for rendering customizable 3D environments according to an embodiment of the present disclosure.

Wherever possible, the same reference numbers will be used throughout the drawings to represent the same parts.

### DETAILED DESCRIPTION OF THE INVENTION

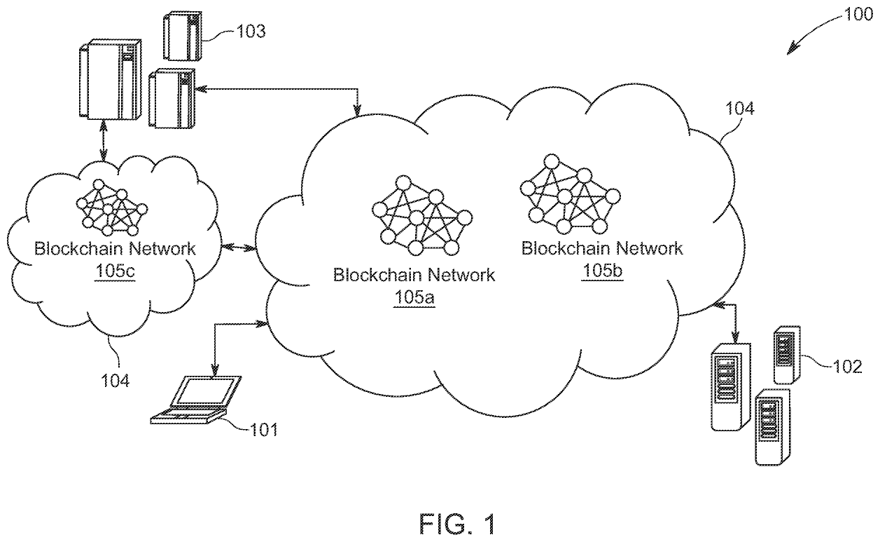

The method and system according to the present disclosure includes a method and system relating to for rendering customizable 3D environments or XR experiences. For example, the customized XR experience may be utilized for displaying visual profiles, such as 3D visual representations, 2D visual representations, documents and/or portals. The method and system according to the present disclosure provides a dynamic virtual or augmented reality 3D environment, providing both a simplified configuration of the environment and digital assets and a simplified user interaction that allows the display and configuration of visual representations. Such simplification permits a user platform that enables easy configuration of the 3D environment that allows, for example, the display and purchase of digital assets within a live-social 3D environment. Unlike prior art systems, the method and system of the present disclosure does not require an engineer or engineer level expertise to configure assets within the 3D environment. Such visual profiles may allow the buying, selling, trading, displaying and transferring digital assets represented by non-fungible tokens and other digital assets in a gallery or mall setting utilizing a computer implemented system utilizing a computing system 100 as shown in FIG. 1.

FIG. 1 includes system 100 including at least one client device 101, at least one database system 102 and/or at least one server system 103 in communication via a network 104. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 1.

Client device 101 may access server applications and/or resources using one or more client applications (not shown) as described herein. Client device 101 may be a mobile device, such as a laptop, smart phone, mobile phones, or tablet, or computing devices, such as a desktop computer or a server, wearables (such as VR or AR Goggles), or embedded devices. Alternatively, client device 101 may include other types of devices, such as game consoles, camera/video recorders, video players (e.g., incorporating DVD, Blu-ray, Red Laser, Optical, and/or streaming technologies), smart TVs, and other network-connected appliances, as applicable.

Database system 102 may be configured to maintain, store, retrieve, and update information for server system 103. Further, database system may provide server system 1130 with information periodically or upon request. In this regard, database system 1120 may be a distributed database capable of storing, maintaining, and updating large volumes of data across clusters of nodes. Database system 102 may provide a variety of databases including, but not limited to, relational databases, hierarchical databases, distributed databases, in-memory databases, flat file databases, XML databases, NoSQL databases, graph databases, and/or a combination thereof.

Server system 103 may be configured with a server application (not shown) that is capable of interfacing with client application and database system 102 as described herein. In this regard, server system 103 may be a stand-alone server, a corporate server, or a server located in a server farm or cloud-computer environment. According to some examples according to the present disclosure, server system 103 may be a virtual server hosted on hardware capable of supporting a plurality of virtual servers.

Network 104 may include any type of network. For example, network 104 may include a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The network 140 may be any of a variety of available networks, such as the Internet, and represents a worldwide collection of networks and gateways to support communications between devices connected to the network 140.

The system 100 may also comprise one or more distributed or peer-to-peer (P2P) networks, such as a first, second, and third blockchain network 105a-c (generally referred to as blockchain networks 105). As shown in FIG. 1, the network 105 may comprise the first and second blockchain networks 105a and 105b. The third blockchain network 105c may be associated with a private blockchain, and is thus, shown separately from the first and second blockchain networks 105a and 105b. Each blockchain network 105 may comprise a plurality of interconnected devices (or nodes). As discussed below, a ledger, or blockchain, is a distributed database for maintaining a growing list of records comprising any type of information. A blockchain may be stored at least at multiple nodes (or devices) of the one or more blockchain networks 104.

The data transferred to and from various computing devices in a system 100 may include secure and sensitive data, such as confidential documents, customer behavior, customer personally identifiable information, and financial data (e.g., account data, credit card information, banking information and crypto wallet information). Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML, encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 100 in front of one or more computing devices such that any external devices may communicate directly with the specialized hardware.

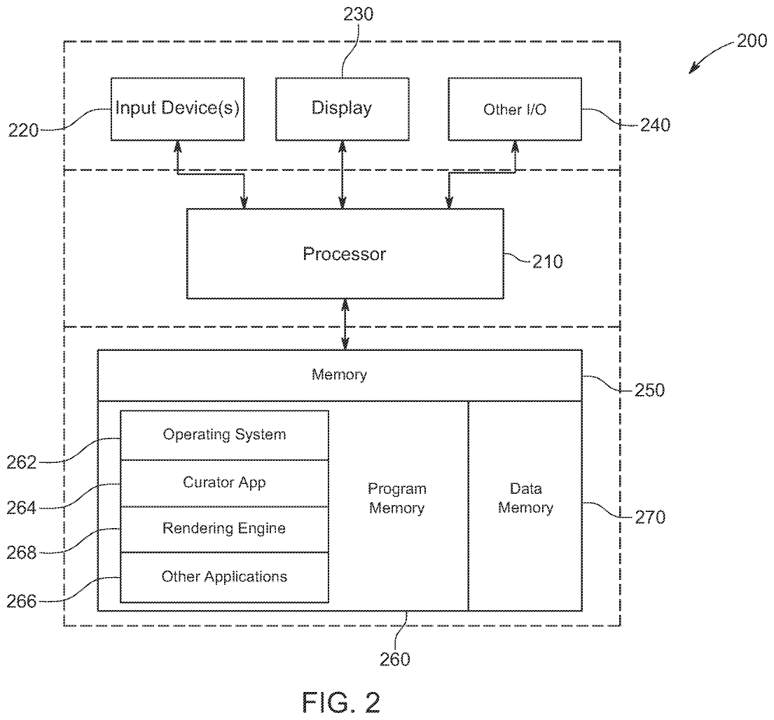

FIG. 2 illustrates a computing device 200 suitable for use in connection with the methods and systems according to the present disclosure. In one embodiment, computing device 200 is utilized with system 100 of FIG. 1, according to an embodiment of the present disclosure. For example, the computing device 200 can be incorporated in various components of the system 100 of FIG. 1, such as the client device 101, database system 102 and/or the server 103. The computing device 200 includes one or more processors 210 (e.g., CPU(s), GPU(s), HPU(s), etc.). The processor(s) 210 can be a single processing unit or multiple processing units in a device or distributed across multiple devices. The processor(s) 210 can be coupled to other hardware devices, for example, with the use of a bus, such as a PCI bus or SCSI bus. The processor(s) 210 can be configured to execute one more computer-readable program instructions, such as program instructions to carry out any of the methods described herein.

The computing device 200 can include one or more input devices 220 that provide input to the processor(s) 210, e.g., to notify it of actions from a user of the device 200. The actions can be mediated by a hardware controller that interprets the signals received from the input device and communicates the information to the processor(s) 210 using a communication protocol. Input device(s) 220 can include, for example, a mouse, a keyboard, a touchscreen, an infrared sensor, a touchpad, a wearable input device, a camera- or image-based input device, a microphone, or other user input devices.

The computing device 200 can include a display 230 used to display various types of output, such as text, models, video, avatars, virtual environments, graphics, and/or images. In some embodiments, the display 230 provides graphical and textual visual feedback to a user. The processor(s) 210 can communicate with the display 230 via a hardware controller for devices. In some embodiments, the display 230 includes the input device(s) 220 as part of the display 230, such as when the input device(s) 220 include a touchscreen or is equipped with an eye direction monitoring system. In alternative embodiments, the display 230 is separate from the input device(s) 220. Examples of display devices include an LCD display screen, an LED display screen, a projected, holographic, or augmented reality display (e.g., a heads-up display device or a head-mounted device), and so on.

Optionally, other I/O devices 240 can also be coupled to the processor(s) 210, such as a network card, video card, audio card, USB, firewire or other external device, camera, printer, speakers, CD-ROM drive, DVD drive, disk drive, or Blu-Ray device. Other I/O devices 240 can further include input ports for receiving data from these types of machines from other sources, such as across a network or from previously captured data, for example, stored in a database.

In some embodiments, the computing device 200 also includes a communication device (not shown) capable of communicating wirelessly or wire-based with a network node over network 104. The communication device can communicate with another device or a server through a network using, for example, TCP/IP protocols. The computing device 200 can utilize the communication device to distribute operations across multiple network devices.

The computing device 200 may include memory 250, which may be in a single device or distributed across multiple devices. Memory 250 includes one or more of various hardware devices for volatile and non-volatile storage and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, device buffers, and so forth. Memory is not a propagating signal divorced from underlying hardware; a memory is thus non-transitory. In some embodiments, the memory 250 is a non-transitory computer-readable storage medium that stores, for example, programs, software, data, or the like. In some embodiments, memory 250 can include program memory 260 that stores programs and software, such as an operating system 262, a curator application 264, rendering engine application 268 and other application programs 266. The curator application(s) 264 may include one or more modules including instructions, configured to perform the various methods described herein. The rendering engine module 268 instructions, data or code that are written to implement image rendering, such as interactive real-time image application programs. While FIG. 2 shows both the curator application 264 and the rendering engine application 268 as both being present in the same computing device 200, the disclosure is not so limited. For example, the curator application 264 and the rendering engine application 268 may be in different computing devices 200. Memory 250 can also include data memory 270 that can include, e.g., reference data, configuration data, settings, user options or preferences, etc., which can be provided to the program memory 260 or any other element of the computing device 200.

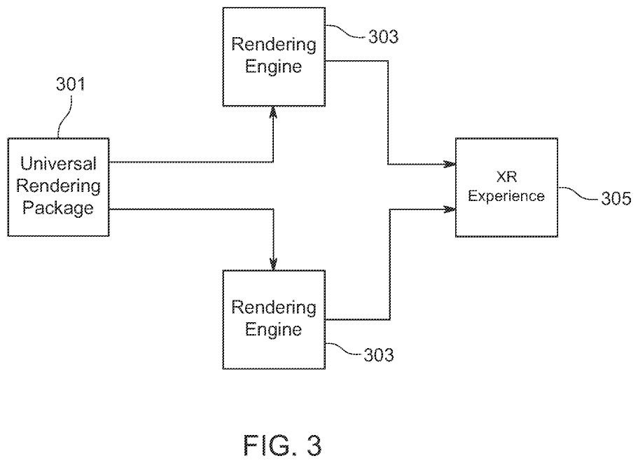

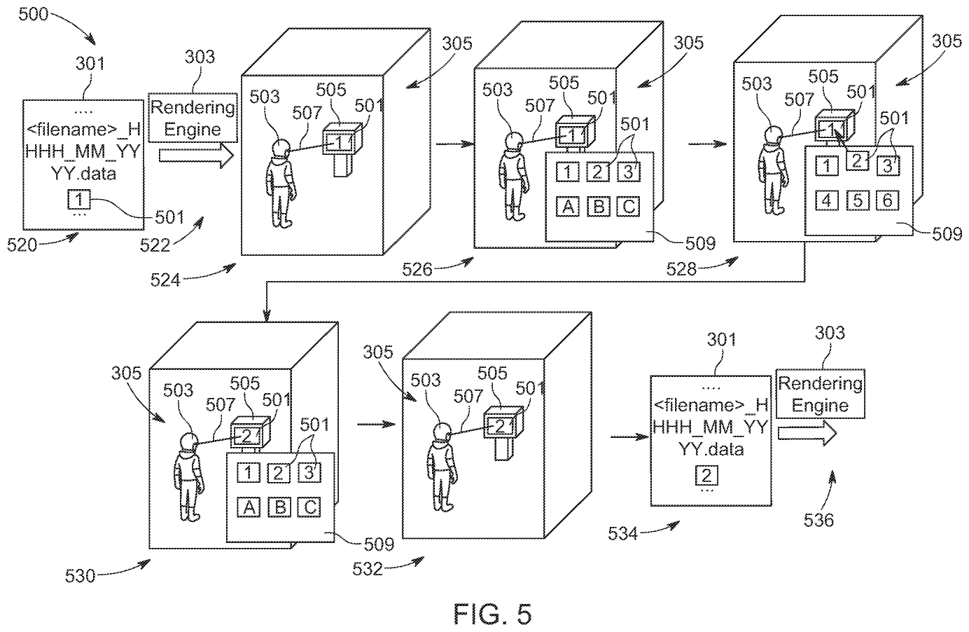

FIG. 3 shows a system configuration illustrating the process flow according to an embodiment of the present disclosure for rendering customizable 3D environments forming the XR experience 305. As shown in FIG. 3, a universal rendering package 301 is generated and transmitted to one or more rendering engines 303. The universal rendering package 301 includes instructions, data or code that corresponds to rendering instructions readable by one or more rendering engines 303. The universal rendering package 301 is configured to be readable by multiple types of rendering engines 303 without further modification of the universal rendering package 301. The universal rendering package 301 is generated by copying data, such as location or address information, from the selected scene within the XR experience 305, and writing this data to the universal rendering package 301. In one embodiment, the universal rendering package 301 includes a JSON file. In this embodiment, the JSON file is an array of objects in JSON format that describes the locations of existing objects. The JSON file universal rendering package 301 is then altered when the user edits the scene using curator 401. For example, an empty frame 505 (see for example, FIG. 5) may be provided in the XR experience 305 (represented within a single data entry in the JSON array) without the image-texture parameter fulfilled, or “blank”. The frame 505 displays a “blank” image. In one example, the universal rendering package 301 may include HTML, so when a document is being rendered by rendering engine 303, universal rendering package 301 will have HTML included within its own object model. Rendering engine 303 is a core component or system, such as component or system of computing device 200 that has been written to implement image rendering, such as the core component of some interactive real-time image application programs. Rendering engine 303 may, for example be a computing device 200 including rendering engine module 268, as shown in FIG. 2. Rendering engine 303 may be provided as a server or a remote device and may provide rapid rendering of images or video to create a 3D environment or XR experience 305. The rendering engine 303 may include, for example, software-based applications or processes that provide a realistic user experience based on a selective mixture of disciplines or models related to, for example, motion physics, acoustic physics, light physics, visual perception, audio perception and mathematics. Suitable rendering engines 303 may include, but are not limited to, the Unity and Unreal game engines. The rendering engine 303 utilizes the universal rendering package 301 to produce, modify or otherwise alter a 3D environment or XR experience 305. The XR experience 305 includes one or more visual profiles. Visual profiles may include one or more of a 3D visual representation, a 2D visual representation, a document and a portal. For example, visual profiles may include 2D textures applied to 3D objects. In this embodiment, these 3D objects are representations of 2D elements, for example, for artwork occurring inside a visible “wooden” frame 505. These frame representations have their own textures and shapes and therefore provide “different representations.”

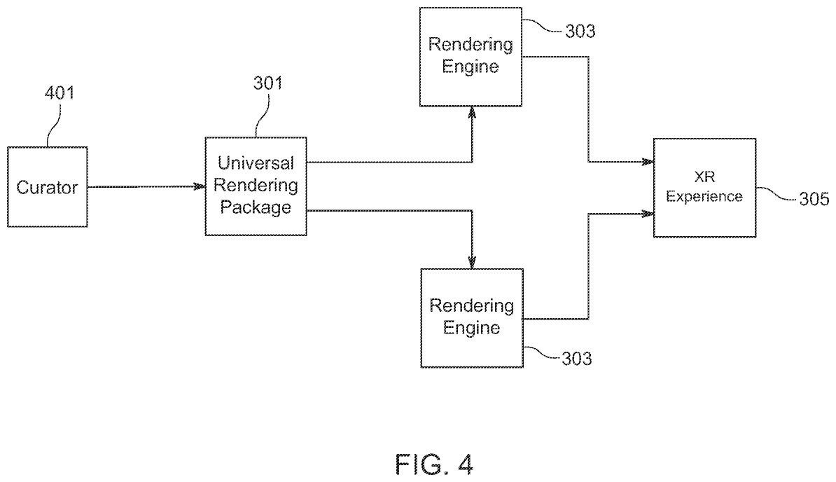

FIG. 4 schematically shows a system configuration illustrating the process flow according to an alternate embodiment of the present disclosure for rendering customizable 3D environments forming the XR experience 305. As shown in FIG. 4, curator 401 is utilized to generate or alter universal rendering package 301. Like in the system shown in FIG. 3, the universal rendering package 301 is transmitted to one or more rendering engines 303. The universal rendering package 301 includes instructions, data or code that corresponds to rendering instructions readable by a rendering engine 303. The rendering engine 303 utilizes the universal rendering package 301 to produce, modify or otherwise alter a 3D environment or XR experience 305.

Curator 401 allows a user to easily schedule and configure visual elements in an online 3-dimensional interactive environment utilizing manipulation of an avatar and the environment. These elements represent visual representations, such as digital assets represented by NFTs or any other digital item, that can be viewed, modified, traded and/or swapped. Once the proposed changes are designated, they are propagated across the network 104 so other users can experience the changes when they visit the 3-dimensional environment according to the scheduling.

Curator 401 is a module within the system according to the present disclosure that includes curator application 264, which are instructions, data or code that allows modification of the XR experience 305 by generation of the universal rendering package 301, such as by generation of an XML, file. Curator 401 allows a similar ease of use and drop and drag simplicity in the virtual world and Web 3.0.

Curator 401 includes an administrative application that schedules and manages inventory for the user's store-gallery installations. Curator 401 allows the user to easily schedule and replace display items, add new display items, manipulate their location, scale and other media metadata. In one embodiment, curator 401 is configured to utilize a drag and drop and point and click solution that simplifies the complex process of that often requires advanced knowledge of 3D systems.

Curator 401 is a first person experience the user can schedule and manipulate media in the gallery or store. After selecting the intended premier date of the installation, the user enters their gallery's show room floor where the user can navigate to any digital painting or media or space and change or add it with another media from the user's inventory. If the user doesn't see what the user wants in the existing inventory, the user can add to the inventory using easy-to-use tools.

Curator 401 permits manipulation of media in the 3D space for purposes of easy configuration of a 3-dimensional interactive environment or XR experience 305. In one embodiment the XR experience includes a 3D Gallery. A 3D Gallery may include a space in which visual profiles, such as an image or video may be displayed. The curator 401 permits maintenance of an inventory of content with the Read/Write/Update/Delete/Sort/Search abilities of the media and the corresponding metadata.

FIG. 5 shows an exemplary embodiment of a method 500 where curator 401, utilizing the curator application 264 of the computing device 200, modifies the universal rendering package 301 to provide a modified XR experience 305. As shown in FIG. 5, a universal rendering package 301 including a visual profile 501 (shown as “1” in FIG. 5) is provided (step 520). The universal rendering package 301 is sent to the rendering engine 303 to be rendered into an XR experience 305 utilizing rendering engine 303 (step 522). The visual profile 501 includes one or more of a 3D visual representation, a 2D visual representation, a document and a portal. For example, visual profiles 501 may include 2D textures applied to 3D objects. Within the XR experience 305, an avatar 503 is maneuvered within the XR experience 305 by the user to a location near a frame 505 (step 524). Avatar 503, as utilized herein, is any visual representation of a user, whether in three dimensions or two dimensions, within the XR experience 305 that allows the user to navigate the XR experience 305. The avatar 503 may be represented in a third-party view, as shown in FIG. 5, but is not so limited and may also be presented in a first party point of view. Frame 505 includes a visual representation within the XD environment 305 onto which the visual profile 501 may be placed. Frame 505 may include a visual representation suitable for association with the visual profile 501 and is not limited to a 3D visual representation or a 2D representation. Likewise, the visual profile 501 is not limited to a 3D visual representation or a 2D representation and may include any visual feature that is perceptible by the user within the XD environment 305. For example, FIG. 5 shows the visual profile 501 to be a 2D representation of an image on a 3D frame 505. However, the disclosure is not so limited, and the visual profile 501 may be, for example, a 3D visual representation (e.g., model, sculpture, avatar or other 3D representation) that is associated with frame 505. Avatar 503 includes a gaze 507 that is a (visible or non-visible) line extending from avatar 503 along a line within the XD environment 305. The gaze 507, as shown in step 524, is directed and contacts visual profile 501. The gaze 507 is controllable by the user of avatar 503. To change the visual profile 501, the curator 401 activates a palette 507 (step 526). The palette 507 may be activated by clicking on the visual profile 501 or may be a “gaze over” wherein the palette 507 opens upon contact of the gaze to the visual profile 501. Palette 507 includes visual profiles to select to replace the visual profile 501 associated with frame 505. Palette 507 may include any number of visual profiles, including one or more of a 3D visual representation, a 2D visual representation, a document and a portal. These visual profiles may be uploaded to the palette 507 in order to be available for use in curator 401. The information or files related to the visual profiles 501 may be saved in curator 401 or may be stored on other computing devices 200, where the curator 401 includes references or links to the visual profiles 501. The user, through avatar 503 may select and replace a base visual profile 501 (represented as “1”) with a modified visual profile 501 (represented as “2”) (step 528). The select and replace may be provided using any suitable technique, including a “drag and drop”, “activate and select” or other known visual manipulation action known for making visual selections. Once the visual profile 501 has been replaced, the palette 509 is displayed to provide the user additional options for visual profile replacement (step 530). In another embodiment, the palette 509 may be closed upon the replacement of the base visual profile 501 with the modified visual profile 501. The palette 509 is closed to show the full XD experience 305 (step 532). Upon the replacement of the visual profile 501, the universal rendering package 301 is modified to include a reference to the modified visual profile 501 (step 534) and the universal rendering package 301 is sent to the rendering engine 303 to render the XD environment 305 with the modified visual profile 301 (step 536).

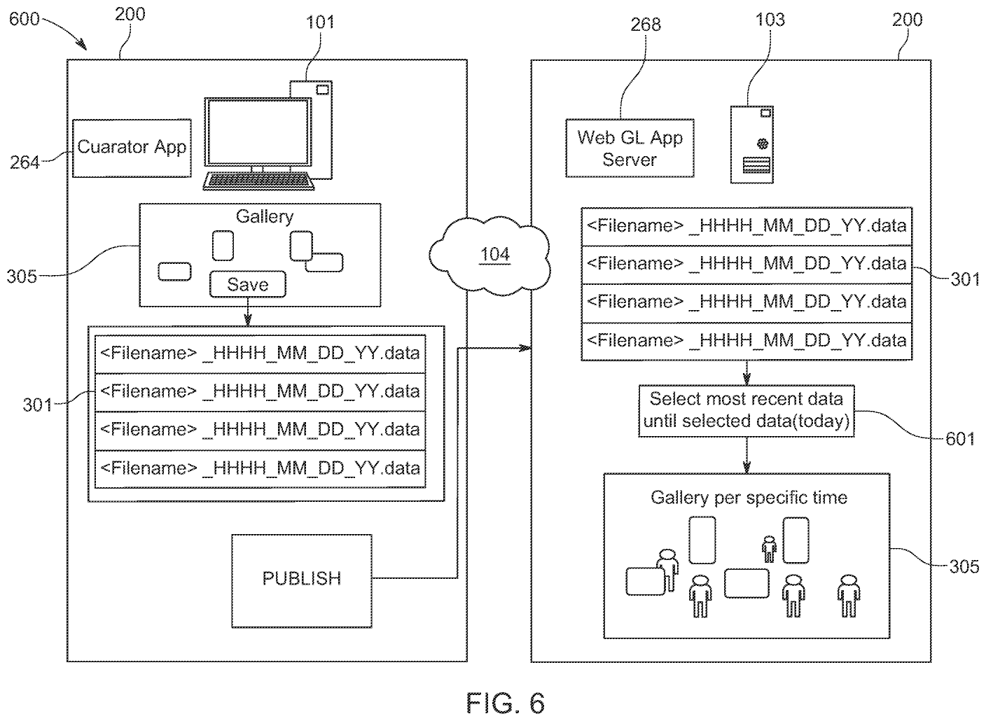

FIG. 6 shows a 3D curating system 600 according to an embodiment of the present disclosure. System 600 includes computing devices 200 made up of a client device 101 and a server system 103. While a single client device 101 and a single server system 103 is shown in FIG. 6, the invention is not so limited. Any number of client devices 101 and server systems 103 may be utilized. The client device 101 includes and executes curator app 264, which permits modification of the XD experience 305. Upon modification of the XD experience 305, a universal rendering package 301 is, when the user selects PUBLISH, is communicated via network 104 to server system 103 where the rendering engine application 268 renders the XD environment 305 using the universal rendering package 301. A timing feature 601 may also be provided wherein the timing feature 601 utilizes scheduling configured by the curator app 264 to select a time for rendering of particular features included in the universal rendering package 301. If the viewing of the visual profile 501 is to happen in the future, a batch upload the visual profiles 501 may be made. If the viewing of the visual profile 501 is current, the scene corresponding to the XR experience 305 may be changed by sending the universal rendering package 301 to the rendering engine 303.

In embodiments according to the present disclosure, curator 401 includes four basic functions:
1) Store Inventory: The master list for all digital acquisitions or visual profiles 501.
2) Floor Media Replacement Tool: Replaces visual profiles 501, including, for example, gallery media with visual profiles 501 from the store inventory.
3) Scheduling: Schedule visual profiles 501 or media for display during certain time periods.
4) Designing: Import, add and manipulate visual profile 501 location, scale and other media-metadata.
5) Inventory: Store operators can add visual profiles 501 including, for example, existing NFTs from a digital source, such as the Stratisphere store, into an inventory, which may be utilized for scheduling.

In one embodiment, for example, the curator 401 may be licensed by purchasing or renting a storefront address in the XD environment 305, such as a Mall space with a client device 101. In one embodiment, in order to license or purchase curator 401, the curator application 266 may be downloaded from an online repository onto the user's local computing device 200 and execute the installer and execute the application. In another embodiment, the curator 401 may be accessed via a web application, wherein a user accessed the web application by visiting a Web URL and loading the web application. In still another embodiment the curator 401 may be accessed via VR Goggles, such as Apple Vision (available from Apple, Inc.), Meta Quest (available from Meta Platforms, Inc.) or other known VR Goggle system. In order to access the curator 401 for use with VR Goggles, the user may download the application from the VR application store.

One aspect of the present disclosure includes the ability to schedule modifications of the 3D environment with curator 401. In one embodiment, to schedule specific visual profiles 501, such as visual showings of the gallery floor inventory from curator 401:
1) Select a start date/time to schedule the user's installation of visual profiles 501. If an installation hasn't been scheduled for the selected date, it presents a copy of most recently scheduled installation.
2) Click inside a frame 505 in which to place a visual profile 501, such as a target image. Frame 505 may be an empty frame, or an existing visual profile 501.
3) Click Replace in the dialog box. The user can scroll through the inventory to find replacement media.
4) Select the item that the user wants to place in the frame or selected area.
(steps 2-4, above, may be replaced with a drag and drop functionality, where a base visual profile 501 is replaced with a modified visual profile 501 by dragging the modified visual profile 501 onto the base visual profile)
5) The new item is now displayed inside the frame.
6) Close the dialog box.
7) The user can continue to select other items for inspection and replacement.
8) Select Done when the user is finished making all the placements.

In one embodiment, a user may select a start date/time to schedule the user's installation of visual profile(s) 501. The curator application 264 loads the virtual gallery and its contents, including visual profile(s) 501, to provide the user a virtual gallery curating experience. The curating experience is a user experience in a 3-dimensional environment that contains static immutable media, dynamic customizable media and the data to describe the environment and its elements.

In one embodiment, curator 401 first loads an empty gallery formed from rendering engine 303. The static gallery includes static immutable media of the visual profile 501 that is represented by building, the landscaping and other media, such as the sky-box that curator 401 is unable to manipulate. This is followed by loading the list of items belonging to the gallery from the universal rendering package 301 for the scheduled time. These items' media elements are each loaded into their respective virtual locations or frames 505, so that curator 401 can decide to keep or replace the media. When avatar 503 gets within a preselected distance from an asset or asset storage location, a pop-up box appears opening the curator application 264. The user clicks inside a frame in which to place the artwork. Alternatively, the user drags and drops visual profile 501 elements onto the media that the user wishes to replace. Curator 401 may display the metadata associated with the visual profile 501.

In order for curator 401 a change in the gallery from the user, the system recognizes the identity of the record that contains the meta-data for a selected object by detecting the object's collider, by using lines emanating from a point or several points outward seeking objects. When they “touch” the collider, it contains the identity of the record and the contents of the record are displayed (see for example FIG. 5).

In order to facilitate the gallery changes or changes in visual profile 501, a click and replace function or drag and drop function may be utilized. Curator 401 loads the user interface (UI) which provides access to all of the inventory, including preloaded visual profiles 501, for the store. Curator 401 gathers the data from the Data Object, which contains all of the records of the elements the store has in its inventory. The user then has the ability to add, remove, and edit the metadata for the items belonging to this inventory, or Database. This may be maintained, for example using the rendering engine's 303, such as Unity's Asset Bundle and Addressable systems in the case of the Decentralized Architecture and it is maintained as any other Enterprise system in the traditional architecture. These systems can live in parallel and are compatible for transactions.

To initiate the placing of a visual profile 501 into a frame 505 or other selected area, curator 401 reassigns the collider's transmitted identity to the record as was selected, where it replaces the media and metadata for the element and writes this information to the universal rendering package 301.

The user may select a visual profile 501 to place in the frame 505 or other selected area curator 401 reassigns the collider's transmitted identity to the record as was selected, where it replaces the media and metadata for the element and writes this information to the universal rendering package 301.

To complete the process the Dialog Box is closed and the user may select Done. Curator 401 may re-display a Calendar selection, so the user can select another date to curate if desired.

There are several ways to add visual profiles 501 to the user's inventory in the curator 401. For example, a user may add a non-fungible token (NFT) from a Blockchain Network 105a, 105b, 105c, such Stratis, and the user can upload a visual profile 501 corresponding to the NFT from the user's desktop or storage system, like Dropbox or One Drive.
1 a) To add an NFT to the inventory in the curator 401, the curator 401 follows a process similar to the process shown and described above. For example, a user may add an NFT by selecting the Add button displayed by the curator 401 and the curator 401 displays a form-interface so the user can add an NFT by its address
b) The user provides information in response to the form interface and submit the information. For example, the Uniform Resource Locator (URL) for the item in the Blockchain Network 105a, 105b, 105c (e.g., Stratisphere Store) may be copied and the copied URL may be passed into the form and submitted. Curator 401 adds the NFT to the user's inventory in the curator 401.
2 a) In another embodiment, media may be uploaded as visual profiles 501 from the user's device or from a cloud provider by selecting an Upload button. In another embodiment, the user may utilize a drag and drop feature to upload the visual profiles 501. Curator 401 displays a form-interface so the user can add media from the user's device or cloud storage system.
b) User provides information on the form interface and submits the information. Curator 401 transfers the visual profile 501 to a storage system where the user may access visual profile 501 later and mint as an NFT.

When the user pastes the URL of the NFT item or other visual profile 501:
1) Curator 401 parses the input, forms a JSON request string to request detail information from the server that is written to the universal rendering package 301.
2) Curator 401 checks whether the item has already been added to the system.
3) Curator 401 parses the response from the server and creates a new NFT for the repository.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below. In addition, the operations shown in the figures, or as discussed herein, are identified using a particular nomenclature for ease of description and understanding, but other nomenclature is often used in the art to identify equivalent operations.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A method for rendering customizable 3D environments, the method comprising:
generating a universal rendering package, including a base visual profile comprising one or more of a 3D visual representation, a 2D visual representation, a document and a portal;
transmitting the universal rendering package to a rendering engine; and
generating the 3D environment with the universal rendering package, the 3D environment including the base visual profile.

2. The method of claim 1, further comprising:
providing, in the 3D environment, a frame including the base visual profile;
editing the frame from a viewpoint of a 3D avatar to create a modified visual profile; and
modifying the universal rendering package to include the modified visual profile;
transmitting the universal rendering package to the rendering engine; and
generating a modified 3D environment with the universal rendering package, the modified 3D environment including the modified visual profile.

3. The method of claim 2, wherein the editing includes a drag and drop of a first visual representation replacing a second visual representation, the second visual representation being included in the modified visual profile.

4. The method of claim 1, wherein the universal rendering package is a JSON file.

5. The method of claim 1, wherein the rendering package is a Unity rendering engine or an Unreal rendering engine.

6. The method of claim 1, wherein the base visual profile includes a digital asset.

7. A non-transitory machine-readable storage medium storing one or more sequences of instructions for rendering customizable 3D environments, which when executed by one or more processors, cause:
a universal rendering package to be generated, the universal rendering package including a base visual profile comprising one or more of a 3D visual representation, a 2D visual representation, a document and a portal;
the universal rendering package to be transmitted to a rendering engine; and
the 3D environment to be generated with the universal rendering package, the 3D environment including the base visual profile.

8. The non-transitory machine-readable storage medium of claim 7, which when executed by one or more processors, further cause:
in the 3D environment, a frame to be provided including the base visual profile;
the frame from a viewpoint of a 3D avatar to be edited to create a modified visual profile;
the universal rendering package to be modified to include the modified visual profile;
the universal rendering package to be transmitted to the rendering engine; and
a modified 3D environment to be generated with the universal rendering package, the modified 3D environment including the modified visual profile.

9. The non-transitory machine-readable storage medium of claim 8, wherein the editing includes a drag and drop of a first visual representation replacing a second visual representation, the second visual representation being included in the modified visual profile.

10. The non-transitory machine-readable storage medium of claim 7, wherein the universal rendering package is a JSON file.

11. The non-transitory machine-readable storage medium of claim 7, wherein the rendering package is a Unity rendering engine or an Unreal rendering engine.

12. The non-transitory machine-readable storage medium of claim 7, wherein the base visual profile includes a digital asset.

13. A computer system configured to render a customizable 3D environment, comprising:
a server comprising one or more processors;
a remote processing device comprising one or more processors; and
each of the server and the remote processing device comprising one or more computer-readable storage mediums storing one or more sequences of instructions, which when executed, cause:
a universal rendering package to be generated, the universal rendering package including a base visual profile comprising one or more of a 3D visual representation, a 2D visual representation, a document and a portal;
the universal rendering package to be transmitted to a rendering engine; and
the 3D environment to be generated with the universal rendering package, the 3D environment including the base visual profile.

14. The computer system of claim 13, which when executed by one or more processors, further cause:
in the 3D environment, a frame to be provided including the base visual profile;
the frame from a viewpoint of a 3D avatar to be edited to create a modified visual profile;
the universal rendering package to be modified to include the modified visual profile;
the universal rendering package to be transmitted to the rendering engine; and
a modified 3D environment to be generated with the universal rendering package, the modified 3D environment including the modified visual profile.

15. The computer system of claim 14, wherein the editing includes a drag and drop of a first visual representation replacing a second visual representation, the second visual representation being included in the modified visual profile.

16. The computer system of claim 13, wherein the universal rendering package is a JSON file.

17. The computer system of claim 13, wherein the rendering package is a Unity rendering engine or an Unreal rendering engine.

18. The computer system of claim 13, wherein the base visual profile includes a digital asset.
